(19) United States
(12) Patent Application Publication
(10) Pub. No.: US 2008/0212578 A1
(43) Pub. Date: Sep. 4, 2008

(54) SYSTEM AND METHOD FOR CONSTRAINED MACHINE ADDRESS LEARNING

(75) Inventors: Wayne Robert Sankey, Plano, TX (US); Ross Alexander Jamieson, Plano, TX (US); John Kevin Weeks, Richardson, TX (US)

Correspondence Address: HAYNES AND BOONE, LLP, 901 Main Street, Suite 3100, Dallas, TX, 75202, US

(73) Assignee: ADVA AG OPTICAL NETWORKING, Munich (DE)

(21) Appl. No.: 11/681,647

(22) Filed: Mar. 2, 2007

(51) Int. Cl. H04L 12/56

(52) U.S. Cl. 370/389; 370/401

(57) ABSTRACT

A system and method for constrained machine address learning comprises provisioning a first network port as being associated with at least one virtual connection at a second network port, and constraining machine address learning to only between the provisioned first network port and its associated at least one virtual connection.

### BACKGROUND

The virtual local area network (VLAN) technology enables communications equipment, such as computers, connected to different local area networks (LANs) to communicate voice, multimedia, and data via a logical network connection. These LANs are often physically connected by an Ethernet bridge or Ethernet switch to a carrier network, which functions to transmit data between the LANs. From the perspective of a customer's communications equipment on one LAN, communicating with another node on the other LAN appears to be no different than communicating with nodes on the same LAN.

MAC learning is a method that is traditionally used to learn the Media Access Control (MAC) address of communication equipment in the network to identify on which port to send the data. Because the MAC address uniquely identifies a machine, it can be thought of as a machine address of the communication equipment. In MAC learning, an Ethernet bridge, in receiving a frame having a source MAC address of xyz from its port n, “learns” that a communication equipment with the MAC address xyz is connected to port n. As a result, the communication equipment having a MAC address matching the destination MAC address responds to the broadcast, and the Ethernet bridge learns the association between the destination MAC address and the port to which the destination communication equipment is connected.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a plurality of network equipments to local area networks (LANs) each having at least one Ethernet virtual circuits (EVCs) of various bandwidths transmitting and receiving data frames over a carrier network;

FIG. 2 is a simplified block diagram illustrating an association of at least one virtual connection and/or port at a first network port with at least one virtual connection and/or port at a second network port coupled to a network equipment such as an access gateway;

FIG. 3 is a simplified block diagram illustrating an example of machine address learning;

FIGS. 4a-4b and 5a-5b are simplified diagrams of a machine address table, a VLAN table, an EVC table, and CAM table accompanying the example shown in FIG. 2;

FIG. 6 is a simplified diagram of an embodiment of a memory structure for machine address learning; and

FIG. 7 is a more detailed diagram of an embodiment of a memory structure for machine address learning.

### DETAILED DESCRIPTION

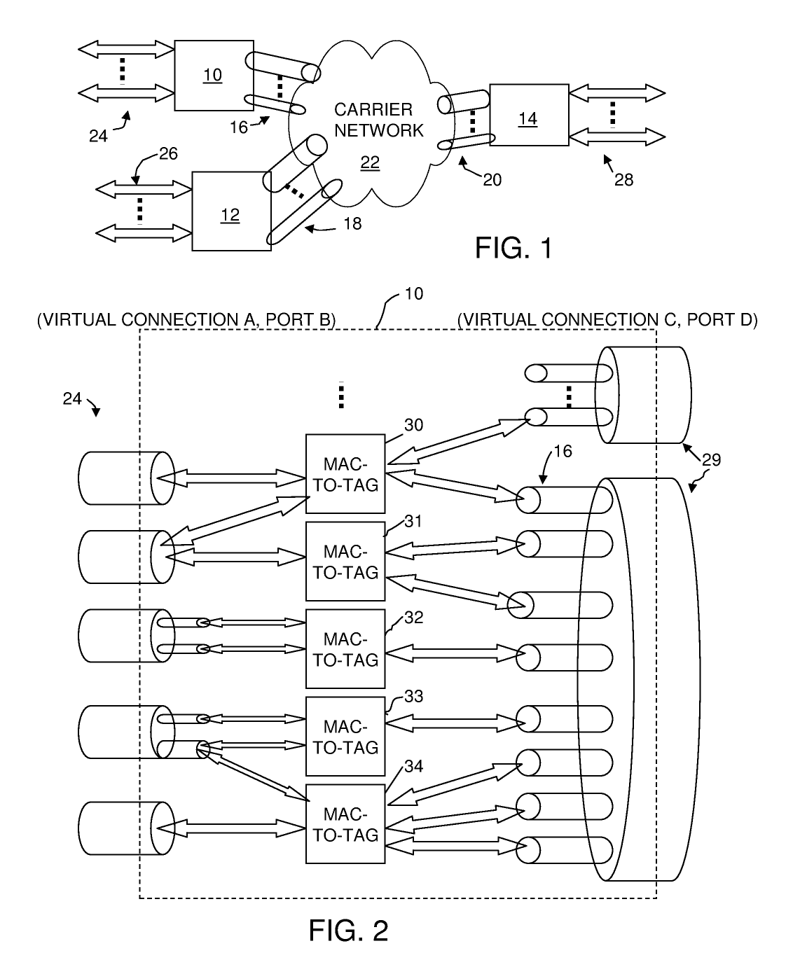

FIG. 1 is a simplified block diagram of a plurality of network equipment 10-14 coupled between local area networks (LANs) and Ethernet virtual circuits (EVCs) 16-20 of various bandwidths in a carrier network 22, such as a wide area network (WAN). Network equipment 10-14 are operable to provide aggregated shaping of multiple prioritized classes of service (CoS) flows 24-28. Preferably, the network equipment support the IEEE 802.1ad, 802.1ag, 802.1d, 802.1q, 802.3ah, and other applicable standards. Hereinafter, the terms local area network and LAN may be used to refer to a computer network that is more localized in nature to connect computers that are co-located or situated at one site. The terms wide area network and WAN may be used to refer to a computer network that spans a relatively large geographical area, and may comprise two or more local area networks.

FIG. 2 is a simplified block diagram illustrating the association or MAC-to-tag bridging of at least one first network port 24 and/or at least one virtual connection at the first network port with at least one virtual connection 16 and/or at least one second network port 29. Stated in a general way, a MAC-to-tag bridge associates at least one first connection entity defined by (virtual connection A, port B) to at least one second connection entity defined by (virtual connection C, port D). For example, the first network port may be a local area network (LAN) port, and the second network port may be a wide area network (WAN) port. MAC-to-tag bridges 30-34 may map or associate the traffic of one or more virtual connection at one or more first network port to one or more virtual connection at one or more second network ports. For example, MAC-to-tag bridges 30-34 may map the traffic on one LAN port 24 to one or more EVCs at the network port 29. MAC-to-tag bridges 30-34 may also map the traffic on one virtual connection on two LAN ports to one or more virtual connections at one WAN network port 29. MAC-to-tag bridges 30-34 may map the traffic on one virtual connection on one network port 24 to a second network port 29.

The MAC-to-tag bridges 30-34 therefore keep the data traffic mapped to each MAC-to-tag bridge segregated from one another, so that there cannot be any mingling of data traffic between MAC-to-tag bridges. Further, MAC learning is constrained so that frame flooding is only done among the constrained connection entities. In the specific example of a LAN port associated with an EVC at the network port, the constrained MAC learning is accomplished by flooding data frames received at a LAN port to all network EVC ports that are part of the bridge associated with the originating LAN port. In other words, this MAC learning is constrained so that broadcast frames from one LAN port are not broadcasted to another LAN port nor between MAC-to-tag bridges for MAC learning. MAC learning is also not performed between WAN EVCs. Therefore, MAC learning is performed only between LAN ports and WAN EVCs that are part of the same MAC-to-tag bridge or grouping. Stated generally, the constrained MAC-to-tag learning described herein is perform between only associated (virtual connection, port) at one network and the (virtual connection, port) at the second network.

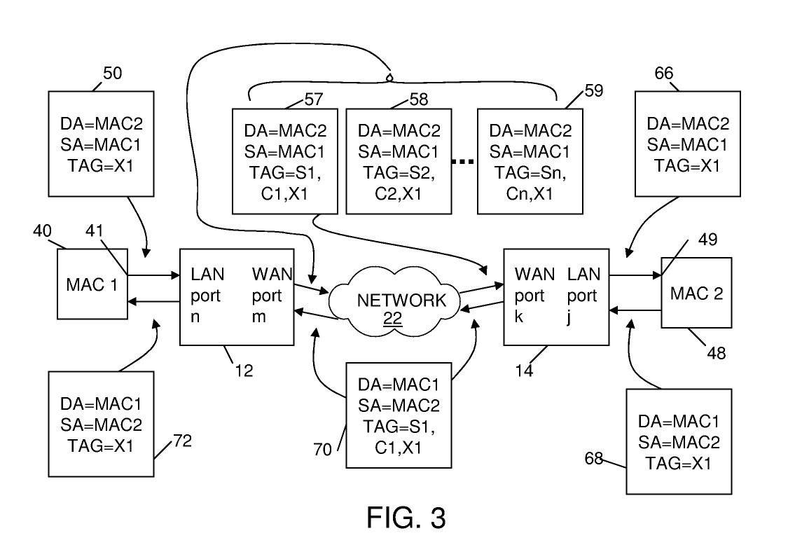

FIG. 3 is a simplified block diagram illustrating an example of machine address learning. Although the example shown in FIG. 3 is a unicast example, machine address learning is also performed for broadcast and multicast frames. A first communication equipment 40 is coupled to a first network equipment 12 at a LAN port n. The network equipment 12 may have a number of other LAN ports each coupled to other communication equipment (not shown). The MAC or machine address of the attached port 41 of the first communication equipment 10 is MAC1. A wide area network (WAN) port m of the network equipment 12 is coupled to a carrier network 22. A second network equipment 14 is coupled to the carrier network 22 at a WAN port k, and its LAN port j is coupled to a second communication equipment 48. The MAC or machine address of the connected port 49 of the second communication equipment 48 is MAC2. The network equipment 14 has a number of LAN ports coupled to other communication equipment (not shown).

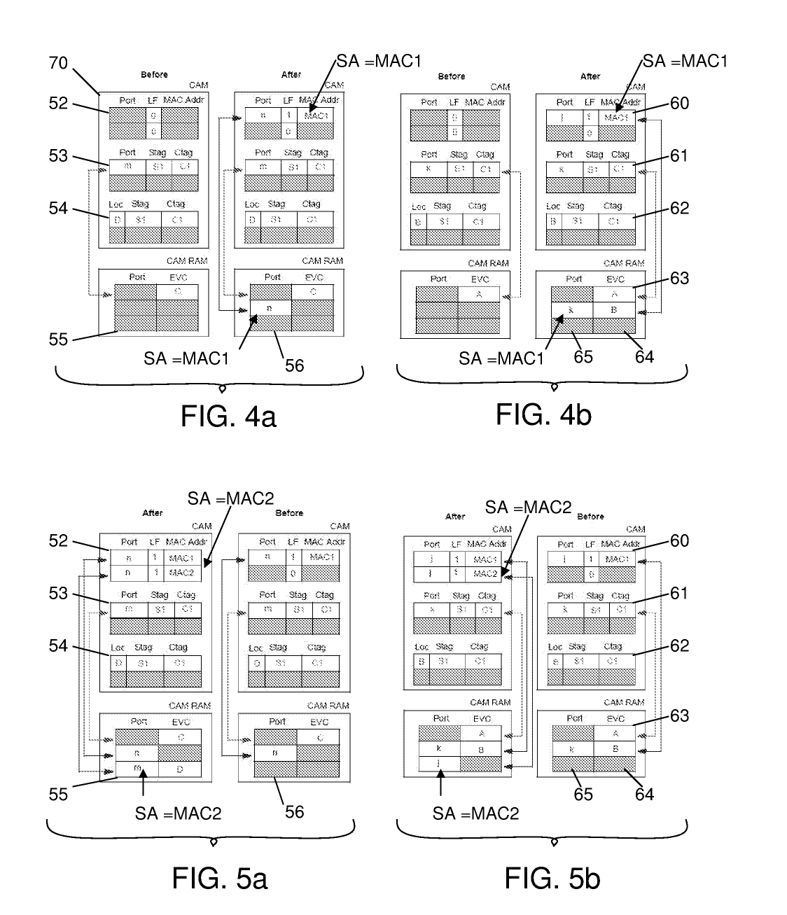

Referring also to FIGS. 4a-4b, a frame 50 is received from communication equipment 40 at LAN port n of the network equipment 12. The frame 50 destination address (DA) is MAC2, source address (SA) is MAC1, and the VLAN tag of the frame is X1. X1 uniquely identifies an EVC connection at LAN port n. FIG. 4a shows a BEFORE state representing a CAM (Content Addressable Memory) 70 which contains MAC table 52, a VLAN table 53, an EVC table 54; and further representing a CAMRAM 55. The MAC table 52 is used to store known or “learned” MAC addresses and a learned flag needed to identify available CAM locations. The EVC table 54 is used to store provisioned EVC's position in the CAM 55. Each location's address in the EVC table directly maps to the CAM entry space to locate the provisioned EVC for a new learned MAC address.

In the frame 50, the destination address, MAC2, and the source port n are used to look up in the MAC table 52, which yields a no-match result since MAC2 is not in the MAC table. Therefore, the frame 50 is duplicated and flooded to all EVCs on the WAN associated with LAN source port n. The frame 50 is thus only flooded to EVCs that belong to the same MAC-to-tag bridge as LAN port n. The replicated frames are directed to the respective WAN EVC ports with S and C VLAN tags specific for each EVC. As shown in FIG. 3, replicated frames 57, 58 and 59 with (S1, C1), (S2, C2), to (Sn, Cn) S and C tags are broadcasted by the network equipment 12. An EVC connection is identified by a unique S and C tag combination at the network or WAN port. The S and C tag values are derived from a software provisioned multicast lookup table (not shown). A lookup on the source MAC address, MAC1, and source port n, in the MAC table 52 also returns a no-match result. As seen in FIG. 4a, an AFTER state shows the first “unlearned” or available entry location in the MAC table 52 is identified or determined by looking at the learned flag (LF) field of each entry, and the MAC1 address and source port n are written to the first unlearned location. The port identifier, n, of the source port associated with the MAC1 address is also written to the CAMRAM port bank 56 of the CAMRAM 55 at a location corresponding to the new CAM 52 entry. The corresponding LF field in the MAC table 52 is set to logic “1” to indicate that the entry now contains a “learned” MAC address. As a result, the machine address MAC1 is now associated with LAN port n.

As seen in FIG. 4b, the network equipment 14 has a MAC table 60, VLAN table 61, EVC table 62, and CAMRAM 63. The two states are labeled BEFORE and AFTER. At the network equipment 14, a frame 57 having VLAN tags S1, C1, and X1 is received. A lookup on the S1 and C1 tags and source port k performed in the BEFORE VLAN table 61 yields the LAN port for frame transport. If the destination port j from the S1 and C1 tag lookup is provisioned for constrained MAC-to-tag learning, a lookup on the source MAC address, MAC1, and destination port j is performed. This lookup returns a no-match result. Therefore as seen in the AFTER state, the source MAC address, MAC1, and the destination port j are entered into a first available location in the MAC table 60. MAC1 is now a learned MAC address. The WAN source port k is also added into the CAMRAM 63 at a location corresponding to the new CAM 60 entry. Source MAC addresses are learned on the WAN ports for the purpose of MAC-to-tag or EVC association. This learning is needed to forward frames from the LAN port to the WAN port, or in the ingress direction. A lookup on the S1 and C1 tags is performed in the EVC table 62 to return the address B needed to serve as the EVC pointer for ingress traffic in to the EVC bank 64 in the CAMRAM 63. This EVC pointer is entered into the CAMRAM 63 MAC learning bank 64 at a location corresponding to the newly learned MAC source address, MAC1. The network equipment 14 strips away the S1 and C1 tags from the frame before passing the frame 66 to the communication equipment 48 via LAN port j.

The communication equipment 48 returns a frame 68 to the network equipment 14 with the destination address as MAC1, the source address as MAC2, and a VLAN tag X1. Referring to FIG. 5b showing the BEFORE state, a look up on the destination MAC address, MAC1, and source port j yields a match result at CAM 60 entry that leads to address B in the EVC bank 64 of CAMRAM 63. The WAN port k and S1 and C1 VLAN tags are returned as a result of the learned MAC1 entry. The S1 and C1 tags are inserted into the frame. A lookup on the MAC source address MAC2 and source port j, yields a no-match result. As seen in the AFTER state, the source MAC address, MAC2 and source port j, are entered into an available location in the CAM MAC table 60 as a newly learned MAC address. The LAN source port j is also added to the CAMRAM MAC learning bank 65 at a location corresponding to the new CAM 60 entry. The network equipment 14 then passes the frame 70 to the network 22, which is received by the network equipment 12.

At the network equipment 12, a lookup on the S1 and C1 VLAN tags and source port m in the VLAN table 53 returns LAN port n for frame transport. If the destination port n from the S1 and C1 tag lookup is provisioned for constrained MAC-to-tag learning, a lookup on the MAC source address, MAC2, and destination port n is performed. This lookup yields a no-match result. The MAC2 address and destination port n are entered into an available location in the MAC table 52 as a newly learned MAC address and is associated with the EVC described by the S1 and C1 VLAN tags. The WAN source port m is added to the CAMRAM 55 MAC learning bank 56 at a location corresponding to the new CAM 52 entry. The S1 and C1 tags are removed before the frame 72 is passed on to the communication equipment 40.

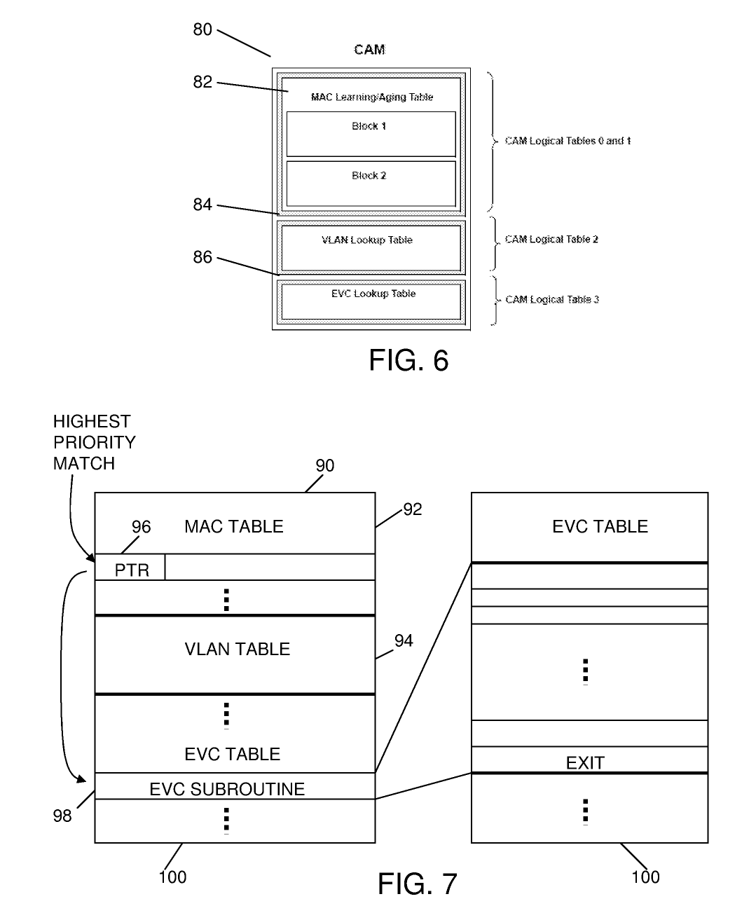

The CAM search results described above are used to determine destination information and modify the VLAN tags. As seen in a simplified diagram of the CAM 80 shown in FIG. 6 and the CAMRAM 90 shown in FIG. 7, a highest priority match in the CAM 80 MAC table 82 or VLAN table 84 yields an absolute address in the CAMRAM 90, at which the EVC pointer 96 is located. The EVC pointer 96 is used to access the EVC subroutine 98 in the EVC table 100. Each subroutine may be a set of 32-bit operations that are executed in order until an EXIT operation. The proper subroutine is located based upon provision information, stored or learned information, frame source port, and the lookup results.

The system and method described above constrains the MAC or machine address learning to associations of certain connection entities, such as LAN ports and EVCs at the network (WAN) port. For each customer side connection entity, there are one or more network side connection entities associated therewith. These associated entities form a MAC-to-tag learning group where data traffic of this learning group is segregated from other connection entities. Expanding on this concept, the method described herein is applicable to a group defined by a connection entity or virtual connection that is any property of a frame which identifies the frame, which may include, Ethernet VLAN, Internet Protocol (IP) source port, Multiprotocol Label Switching (MPLS) label, Provider Backbone Bridge (PBB) Tag, Asynchronous Transfer Mode (ATM) virtual path identifier (VPI) and/or virtual channel identifier (VCI), for example.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. A method of machine address learning at a network equipment having at least one first network port and at least one second network port, comprising:
provisioning a first network port as being associated with at least one virtual connection at a second network port; and
constraining machine address learning to only between the provisioned first network port and its associated at least one virtual connection.

2. The method of claim 1, wherein constraining machine address learning comprises flooding a broadcast frame received from the first network port to only its associated at least one virtual connection.

3. The method of claim 1, wherein constraining machine address learning comprises flooding a multicast frame received from the first network port to only its associated at least one virtual connection.

4. The method of claim 1, wherein constraining machine address learning comprises flooding a frame received from the first network port with an unknown destination machine address to only its associated at least one virtual connection.

5. The method of claim 1, wherein constraining machine address learning comprises forwarding a frame received from the at least one virtual connection with an unknown destination machine address to all network ports associated with the at least one virtual connection.

6. The method of claim 1, wherein provisioning a first network port as being associated with at least one virtual connection at a second network port comprises provisioning a local area network port as being associated with at least one Ethernet virtual circuit at a wide area network port.

7. The method of claim 1, wherein provisioning a first network port as being associated with at least one virtual connection at a second network port comprises provisioning the first network port as being associated with at least one Multiprotocol Label Switching label at the second network port.

8. The method of claim 1, wherein provisioning a first network port as being associated with at least one virtual connection at a second network port comprises provisioning the first network port as being associated with at least one Provider Backbone Bridge tag at the second network port.

9. The method of claim 1, wherein provisioning a first network port as being associated with at least one virtual connection at a second network port comprises provisioning the first network port as being associated with at least one Asynchronous Transfer Mode VPI/VCI at the second network port.

10. A method of machine address learning, comprising:
receiving a frame from a source network port;
parsing the frame and determining a destination machine address and a source machine address;
looking up the destination machine address in a machine address table;
sending a duplicate of the received frame to each virtual connection associated with the source port in response to not finding a match of the destination machine address in a first machine address table;
determining a pointer to a subroutine for determining a destination address in response to finding a match of the destination machine address in the first machine address table;
looking up the source machine address in the first machine address table; and
storing the source machine address in the first machine address table and the source port at a memory location associated with a storage location of the source machine address in the first machine address table, in response to not finding a match of the source machine address in the first machine address table.

11. A method of machine address learning, comprising:
receiving a frame from a source network port;
parsing the frame and determining a destination machine address and a source machine address, the destination machine address indicating a broadcast frame;
sending a duplicate of the received frame to each virtual connection associated with the source port in response to the destination machine address being a broadcast frame;
looking up the source machine address in the first machine address table; and
storing the source machine address in a first machine address table and the source port at a memory location associated with a storage location of the source machine address in the first machine address table, in response to not finding a match of the source machine address in the first machine address table.

12. A method of machine address learning, comprising:
receiving a frame from a source network port;
parsing the frame and determining a destination machine address and a source machine address, the destination machine address indicating a multicast frame;
sending a duplicate of the received frame to each virtual connection associated with the source port in response to the destination machine address being a multicast frame;
looking up the source machine address in the first machine address table; and
storing the source machine address in a first machine address table and the source port at a memory location associated with a storage location of the source machine address in the first machine address table, in response to not finding a match of the source machine address in the first machine address table.

13. The method of claim 10, further comprising:
receiving a duplicate frame from a network port;
parsing the duplicate frame and determining a destination port in response to the virtual connection associated with the destination port in the duplicate frame;
looking up the source machine address and destination port of the duplicate frame in a second machine address table; and
storing the source machine address in the second machine address table in response to not finding a match of the source machine address in the second machine address table.

14. The method of claim 11, further comprising:
receiving a duplicate frame from a network port;
parsing the duplicate frame and determining a destination port in response to the virtual connection associated with the destination port in the duplicate frame;
looking up the source machine address and destination port of the duplicate frame in a second machine address table; and
storing the source machine address in the second machine address table in response to not finding a match of the source machine address in the second machine address table.

15. The method of claim 12, further comprising:
receiving a duplicate frame from a network port;
parsing the duplicate frame and determining a destination port in response to the virtual connection associated with the destination port in the duplicate frame;
looking up the source machine address and destination port of the duplicate frame in a second machine address table; and
storing the source machine address in the second machine address table in response to not finding a match of the source machine address in the second machine address table.

16. A network equipment having at least one first network port and at least one second network port, comprising:
means for provisioning a first network port as being associated with at least one virtual connection at a second network port; and
means for constraining machine address learning to only between the provisioned first network port and its associated at least one virtual connection.

17. The network equipment of claim 16, wherein means for constraining machine address learning comprises means for flooding a broadcast frame received from the first network port to only its associated at least one virtual connection.

18. The network equipment of claim 16, wherein means for constraining machine address learning comprises means for flooding a multicast frame received from the first network port to only its associated at least one virtual connection.

19. The network equipment of claim 16, wherein means for constraining machine address learning comprises means for flooding a frame received from the first network port with an unknown destination machine address to only its associated at least one virtual connection.

20. The network equipment of claim 16, wherein means for constraining machine address learning comprises means for forwarding a frame received from the at least one virtual connection with an unknown destination machine address to the first network port associated with the at least one virtual connection.

21. The network equipment of claim 16, wherein means for provisioning a first network port as being associated with at least one virtual connection at a second network port comprises means for provisioning a local area network port as being associated with at least one Ethernet virtual circuit at a wide area network port.

22. The network equipment of claim 16, wherein means for provisioning a first network port as being associated with at least one virtual connection at a second network port comprises means for provisioning the first network port as being associated with at least one Multiprotocol Label Switching label at the second network port.

23. The network equipment of claim 16, wherein means for provisioning a first network port as being associated with at least one virtual connection at a second network port comprises means for provisioning the first network port as being associated with at least one Provider Backbone Bridges at the second network port.

24. The network equipment of claim 16, wherein means for provisioning a first network port as being associated with at least one virtual connection at a second network port comprises means for provisioning the first network port as being associated with at least one Asynchronous Transfer Mode VPI/VCI at the second network port.

25. A method of machine address learning at a network equipment having at least one first network port and at least one second network port, comprising:
provisioning at least one virtual connection at least one first network port as being associated with at least one virtual connection at least one second network port; and
constraining machine address learning to only between the provisioned at least one virtual connection at the at least one first network port and its associated at least one virtual connection at the at least one second network port.

26. A method of machine address learning at a network equipment having at least one first network port and at least one second network port, comprising:
provisioning at least one virtual connection at least one first network port as being associated with at least one second network port; and
constraining machine address learning to only between the provisioned at least one virtual connection at the at least one first network port and its associated at least one second network port.

27. A network equipment having at least one first network port and at least one second network port, comprising:
means for provisioning at least one virtual connection at least one first network port as being associated with at least one virtual connection at least one second network port; and
means for constraining machine address learning to only between the provisioned at least one virtual connection at the at least one first network port and its associated at least one virtual connection at the at least one second network port.

28. A network equipment having at least one first network port and at least one second network port, comprising:
means for provisioning at least one virtual connection at least one first network port as being associated with at least one second network port; and
means for constraining machine address learning to only between the provisioned at least one virtual connection at the at least one first network port and its associated at least one second network port.
